(19) United States
(12) Patent Application Publication
(10) Pub. No.: US 2024/0019654 A1
(43) Pub. Date: Jan. 18, 2024

(54) MOLDED BULKHEAD FITTING IN COVER OF FIBER OPTIC CABLE CLOSURE/HOUSING

(71) Applicant: Steven E. Kaplan, Elyria, OH (US)

(72) Inventor: Steven E. Kaplan, Elyria, OH (US)

(21) Appl. No.: 18/220,920

(22) Filed: Jul. 12, 2023

Related U.S. Application Data
(60) Provisional application No. 63/388,459, filed on Jul. 12, 2022.

(51) Int. Cl. G02B 6/44

(52) U.S. Cl. CPC G02B 6/4471

(57) ABSTRACT

A fiber optic cable closure and method of forming the fiber optic cable closure are disclosed. The closure includes a housing having a base and a cover. The cover includes multiple ports each dimensioned to receive an associated drop cable. A bulkhead assembly joins associated connectors to associated optical fibers, and the bulkhead assembly includes a body formed as part of the housing cover. Preferably, an outer perimeter of the body is molded to the housing cover to form an integrated component that eliminates components such as separate seal members between the body and cover.

This application claims the priority benefit of U.S. provisional application Ser. No. 63/388,459, filed Jul. 12, 2022, the entire disclosure of which is incorporated herein by reference.

### BACKGROUND

This disclosure relates to fiber optic closures or housings, and more particularly to an integrated molded bulkhead fitting used in the closure cover.

Fiber optic closures are widely used in the telecommunications industry (e.g., for fiber optic cables) and provide flexibility, reliability, and compact footprints to encourage fast and easy subscriber drop installation in various applications. These types of closures are typically available in a variety of formats, and may include different numbers of ports (2, 4, 6, 8 and 12 port terminals), different mounting options, etc., to meet specific network requirements. Standard fiber optic connectors (such as applicant's own commercially available OptiTap® connectors) are joined to the closure via a fiber access bulkhead. Hardened connectors and drop assemblies make the interconnection highly resistant to wear and tear.

The environmental protected connectors and drop assemblies allow for fast and easy installation of the subscriber drop. The unique re-enterable housing allows for easy access to the fiber connectors. Mounting capabilities allow for use in various network applications or designs, e.g., aerial, pole, pedestal, or underground/vault mounts. Either flat and round drop cables can be accommodated, and the drop cables may be factory terminated or field installed. The cover of the enclosure accommodates the bulkhead adapter such as applicant's own commercially available Surelight® IP Bulkhead adapter. A base of the closure has a central strength member clamp that secures the input fiber to the closure. The base also preferably has a slack management bracket to properly route the fiber on the inside of the closure.

A need exists for an improved arrangement that provides at least one or more of the above-described features, as well as still other features and benefits.

### SUMMARY

A fiber optic cable closure includes a housing having a base and a cover. The cover has multiple ports each dimensioned to receive an associated drop cable. A bulkhead assembly joins associated connectors to associated optical fibers, and the bulkhead assembly including a body formed as part of the housing cover.

An outer perimeter of the body of the bulkhead assembly is preferably formed as part of the housing cover.

More preferably, the body is integrally molded to the housing cover.

The bulkhead assembly includes (i) a shroud subassembly that forms an interface between associated optical fibers received through opposite ends thereof, (ii) a flange that receives a first end of the shroud subassembly, the flange being received in one end of the body, and (iii) a seal received over the flange for sealing between the flange and the body.

A method of forming a fiber optic cable closure includes providing a housing including a base and a cover. The cover includes multiple ports each dimensioned to receive an associated drop cable. The method also includes providing a bulkhead assembly for joining associated connectors to associated optical fibers, and including a body as a part of the bulkhead assembly. The method further includes forming the body of the bulkhead assembly formed as part of the housing cover.

The body forming step includes forming an outer perimeter of the body of the bulkhead assembly as part of the housing cover.

The body forming step preferably includes integrally molding the body to the housing cover.

The method further including (i) providing a shroud subassembly that forms an interface between associated optical fibers received through opposite ends thereof, (ii) including a flange that receives a first end of the shroud subassembly, the flange being received in one end of the body, and (iii) receiving a seal over the flange for sealing between the flange and the body.

One benefit of the new closure and associated method relates to a reduced number of components (at least three less components) in the bulkhead assembly achieved by integrally molding the body to the closure cover when compared to the number of components used in the prior art bulkhead assembly.

Another advantage resides in the reduced assembly time.

Still another benefit is associated with the reduced potential for incorrect assembly and thus improves quality control.

Yet another advantage results from eliminating manufacture and inventory issues previously associated with these multiple components.

The potential for water ingress is likewise reduced.

Still other benefits and advantages of the present disclosure will become more apparent from reading and understanding the following detailed description.

### BRIEF DESCRIPTION OF THE DRAWINGS

FIG. 1 is a perspective view of a prior art fiber-optic cable closure or housing.

FIG. 2 is a bottom plan view of the closure of FIG. 1.

FIG. 3 is a front elevational view of the closure of FIG. 1.

FIG. 4 is a perspective view of a conventional hardened connector coupler with a dust cap shown tethered thereto.

FIG. 5 is a perspective view of a prior art bulkhead adapter assembly with a dust cap shown closed over one end thereof.

FIG. 6 is a perspective view of the bulkhead adapter assembly of FIG. 5 with the cap shown removed from and tethered to the body.

FIG. 7 is an exploded view of the various components of the bulkhead adapter assembly of FIG. 5.

FIG. 8 is a rear perspective view of the body of the adapter assembly of FIG. 7.

FIGS. 9 and 10 are perspective views of a new closure or housing taken from a top and right side, and top and left side, respectively.

FIG. 11 is a perspective view of the underside of the closure removed from a base member (not shown).

FIG. 12 is a front elevational view of the closure of FIG. 9.

FIG. 13 is a side elevational view of the closure of FIG. 9.

FIG. 14 is a top plan view of the closure of FIG. 9.

FIG. 15 is an exploded perspective view of the individual components of the closure of FIGS. 9-14.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

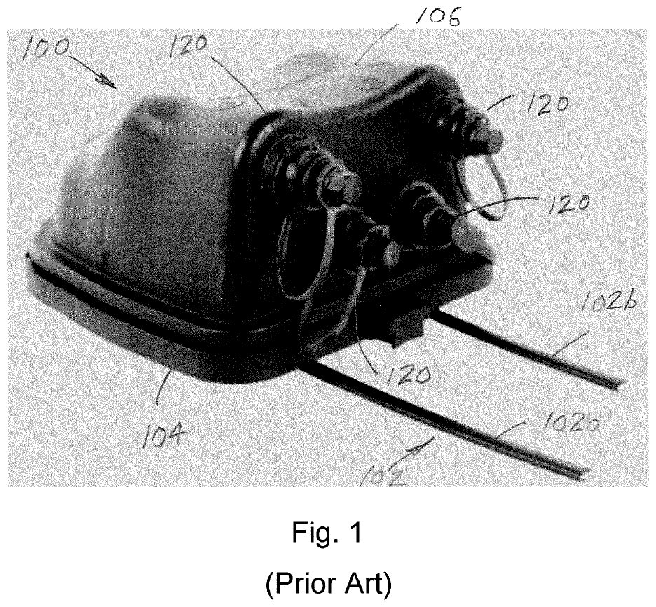

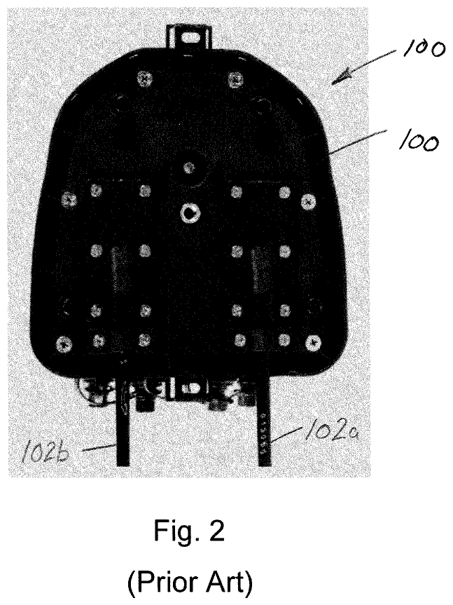

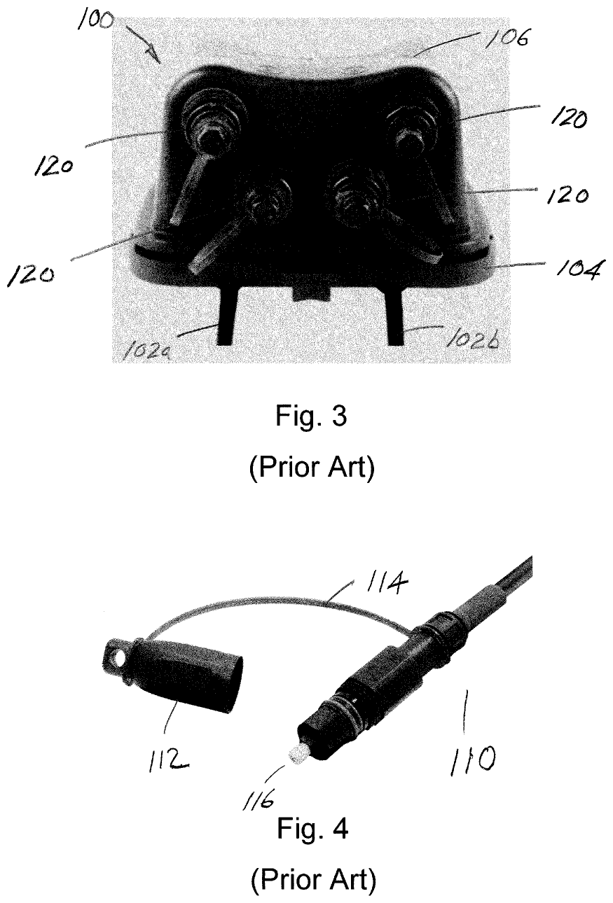

A prior art closure or housing assembly 100 for a fiber optic cable 102 is shown in FIGS. 1-3. Incoming and outgoing fiber optic cable(s) 102a, 102b, respectively, are secured to a base member 104 of the closure assembly 100. A cover 106 of the closure assembly 100 encloses an internal cavity that provides the desired slack storage and protects interconnections made in a splice tray (not shown) between individual optical fibers (not shown) of the fiber optic cable 102 and individual drop lines 110 (FIG. 4). The drop lines 110 include a dust cap 112 connected to the drop line via a tether 114. When the dust cap 112 is removed, a terminal end 116 of the drop line is inserted into an adapter assembly or bulkhead assembly 120. Four bulkhead assemblies 120 are illustrated in FIGS. 1-3, although as is well known in the art, a greater or lesser number of bulkhead assemblies may be provided in the cover 106 of the closure assembly 100. One of the prior art bulkhead assemblies is shown in Figure and includes a dust cap 122 thereof installed on an outer end thereof. In FIG. 6, the dust cap 122 is shown removed and connected via tether 124 to the outer end of the bulkhead assembly 120. When the dust cap 122 of the bulkhead assembly 120 is removed, it provides access to a recess dimensioned to receive the terminal end 116 of a drop line 110 (FIG. 4). Although not shown in joined connection, the dust caps 112, 122 of the drop line 110 and bulkhead assembly 120, respectively, are preferably joined together (e.g., threaded together) when the terminal end 116 of the drop cable 110 is received and mounted securely in the bulkhead assembly.

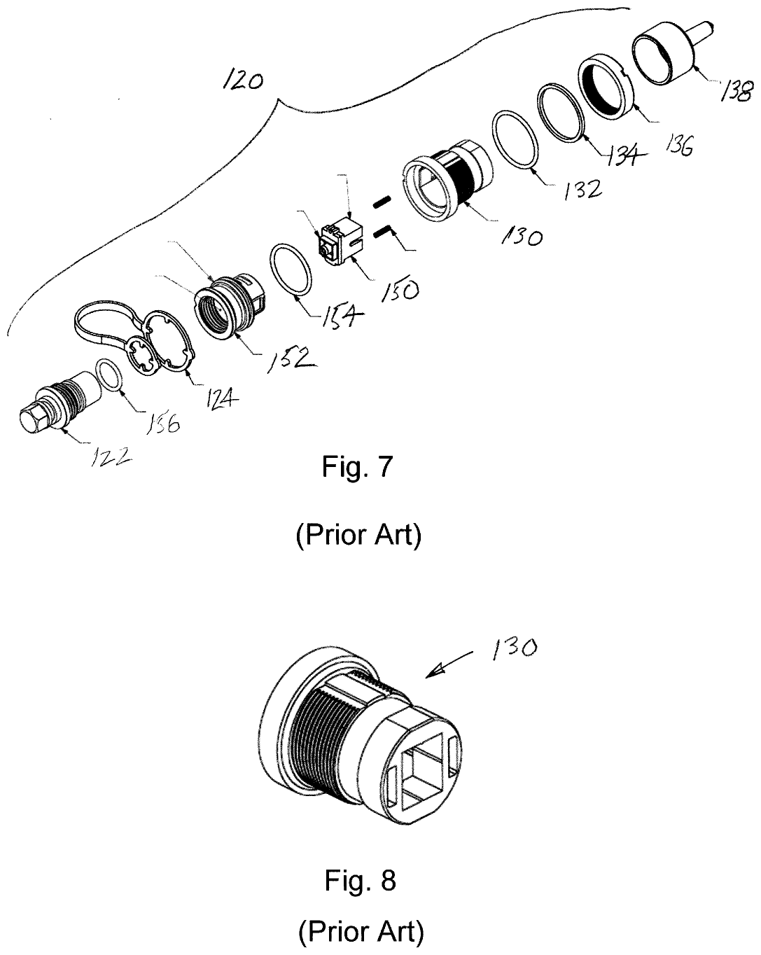

In FIG. 7, the bulkhead assembly 120 is shown in an exploded perspective view that particularly illustrates the various components that comprise one preferred arrangement of a bulkhead assembly. Similar bulkhead assemblies are shown and described in connection with differently configured closure assemblies in the prior art, for example, as shown and described in U.S. Pat. Nos. 5,778,122 and 7,653,282, the entire disclosures of which are expressly incorporated herein by reference. As shown in FIG. 7, a preferred form of adapter assembly or bulkhead assembly 120 includes at least the following components. A body 130 (also shown in FIG. 8) receives first and second seal members 132, 134 over a first end thereof that is dimensioned for receipt in and mounted in an opening/port in the cover 106 of the closure assembly 100. An internally threaded nut 136 (FIG. 7) is also received over the first end of the body 130, and is threadedly coupled to the external threads on the body to maintain the seal members 132, 134 in assembled position. A cover 138 is also received over the first end of the body 130 and abuts against the nut 136.

A shroud subassembly 150 (FIG. 7) is received in the body 130 and provides a primary interface between optical fibers received through opposite ends of the bulkhead assembly 120. A flange 152 receives a front end of the shroud subassembly 150 therein, and the flange is received in an opposite, second end of the body 130. A third seal member 154 is received over the flange 152 and sealingly interconnects the flange with the body 130 when the components of the bulkhead assembly 120 are assembled together. As is also evident in FIG. 7, the flange 152 is internally threaded at one end to threadably receive the removable cap 122 therein. In addition, a fourth seal member 156 is received over the cap 122 to provide a sealed interface between an outer diameter of an insertion end of the cap and an inner diameter portion of the flange 152.

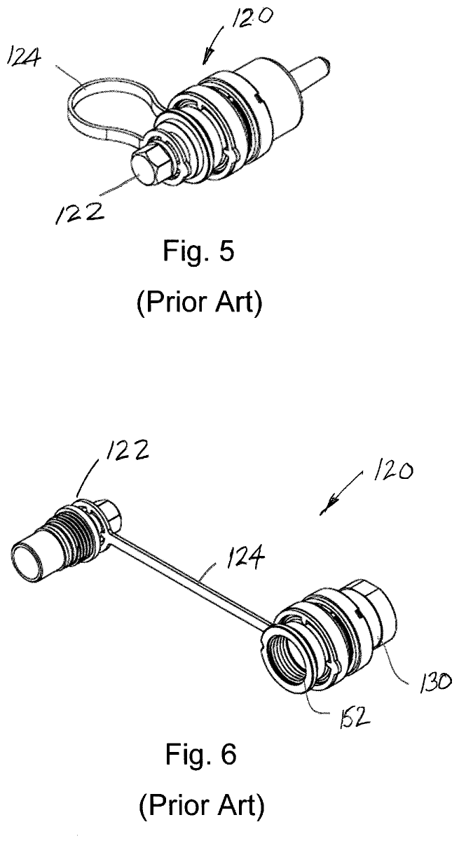

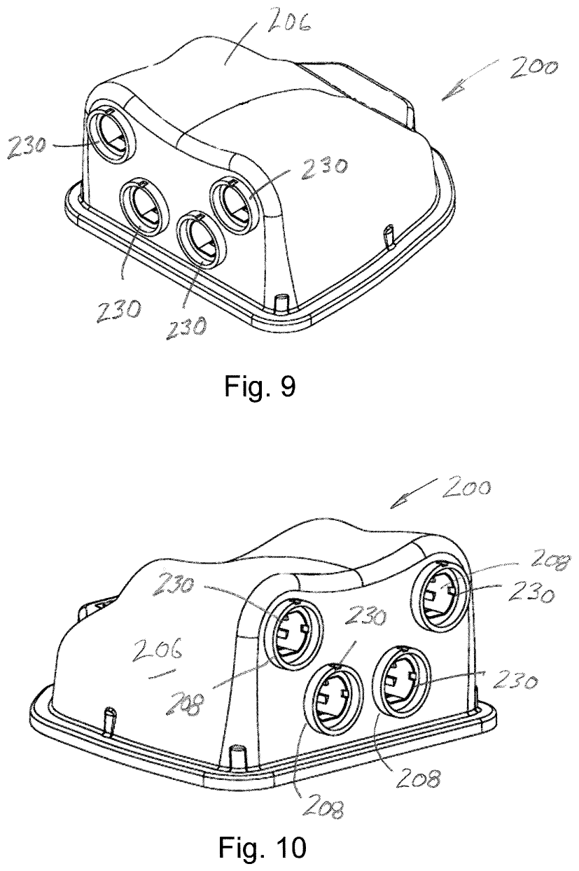

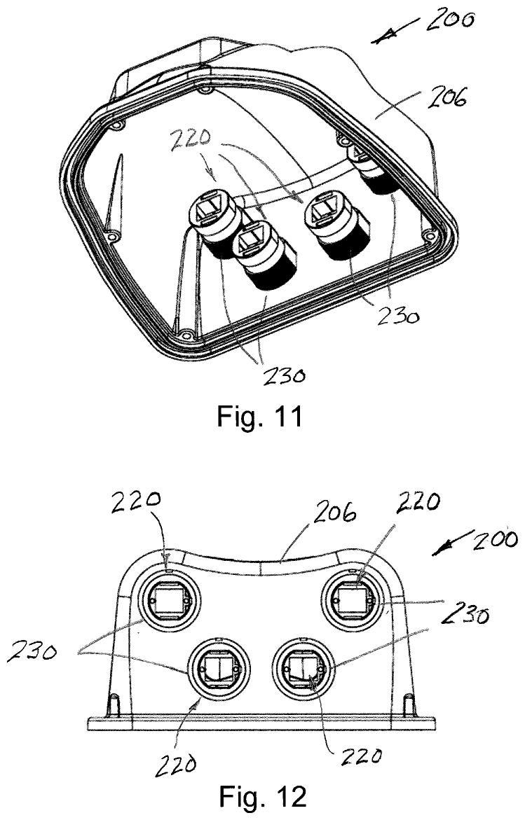

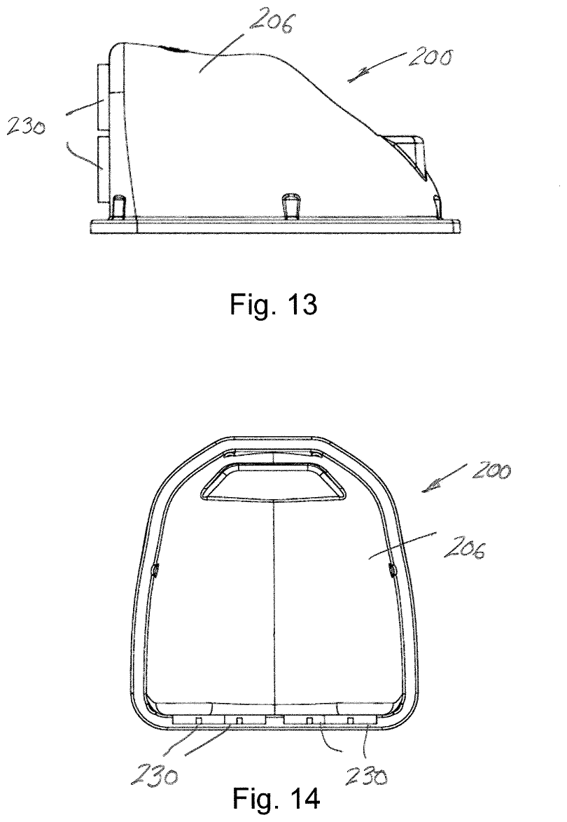

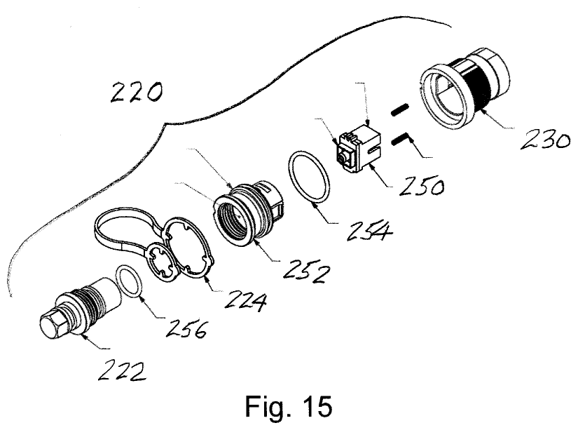

Turning next to FIGS. 9-14, there is shown a modified closure assembly 200 and the generally planar base member is removed for ease of illustration, although it is understood that the closure assembly will include a base member. For ease of reference, and where appropriate, like reference numerals in the 200 series are used to refer to like components, e.g., body 130 of the prior art arrangement described in FIGS. 1-8 correlates to body 230 in the preferred embodiment of the present disclosure in FIGS. 9-15. The closure assembly 200 includes a cover 206 similarly configured to the cover 106 of FIGS. 1-3. Here, however, the cover 206 is modified to include as a part of the cover a portion, and preferably an integrated portion (e.g., integrally molded), of the bulkhead assembly for sealingly joining the drop lines (not shown) to the closure assembly 200. Specifically, each of ports 208 are modified to include body 230 as a part thereof and preferably integrally molded to the cover so that the cover and body are a single component. Each body 230 is similarly configured to body 130 shown individually in FIG. 8 and as part of the assembled views of FIGS. 5 and 6 and the exploded view of FIG. 7. Here, in accordance with the teachings of the present disclosure, each body 230 is formed with the cover, and preferably molded as an integrated part of the cover 206, and each body 230 is still dimensioned to receive a corresponding shroud subassembly (not shown for ease of illustration). Although four ports 208 are shown in the cover 206 of the closure assembly 200 in FIGS. 9-15, it is again understood by one of ordinary skill in the art that a greater or lesser number of ports, and likewise integrated bodies 230, can be provided to form a portion of the individual bulkhead assemblies. By preferably integrally molding the body 230 to the cover 206, greater precision is achieved in the overall assembly and tolerance stack up associated with assembling multiple components into an assembly is also thereby reduced. A reduced, lesser number of components are required in the bulkhead assembly 220 of FIGS. 9-15 when compared to the bulkhead assembly 120 of the prior art arrangement of FIGS. 1-8. Particularly, a number of components are eliminated in this integrated body 230 molded into the cover 206, namely, first and second seals or O-rings 132, 134, and the threaded nut 136 as shown and used in FIG. 7 are all components that are eliminated and need not be incorporated into the preferred assembly of FIGS. 9-15. In addition, the reduced number of components also improves quality control because a seal is not inadvertently omitted with the integrally formed body 230 and cover 206. FIG. 15 illustrates the integrated body 230 as a “separate” component for ease of illustration, although one skilled in the art will appreciate that the body 230 is actually molded (i.e., preferably integrally formed/molded with the cover) with the cover 206 as described above and shown in FIGS. 9-14. The integrated body 230 is not a separate, non-integrated component from the cover 206; however, this is only for ease of illustration and comparison with the prior art arrangement of FIG. 7. Specifically, in FIG. 7, the body 130 was separately formed and subsequently assembled or mounted to the cover 106. With the present disclosure, one skilled in the art will appreciate that the body 230 is made as a part of the cover 206, i.e., preferably molded with the cover, in order to form an integrated, one-piece structure, that receives the remaining components of the bulkhead assembly 220 as shown in FIG. 15. Particularly, that portion of the integrally molded body 230 that extends beyond the outer surface of the cover 206 is evident in FIGS. 9, 10, and 12-14, and is similar in dimension to the extent of axial extension of the separately formed body 130 when assembled to the cover 106 of FIGS. 1-8. FIG. 11 also illustrates the accessibility of the inner surface of the integrally molded body 230 where the inner receiving end of the body 230 extends inwardly into the cavity of the fiber optic cable closure/housing 200.

The reduced number of components in the bulkhead assembly 220 achieved with the integrally molded body 230 of FIGS. 9-15 (at least three less components) when compared to the number of components used in the prior art bulkhead assembly 120 of FIGS. 1-8 advantageously reduces assembly time, reduces the potential for incorrect assembly and thus improves quality control, and also eliminates manufacture and inventory issues previously associated with these multiple components. Still further, due to the reduction in tolerance stack up issues, water ingress is reduced in the new closure assembly 200 when compared to the arrangement of the prior art closure assembly 100.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

What is claimed is:

1. A fiber optic cable closure comprising:
a housing having a base and a cover, the cover including multiple ports each dimensioned to receive an associated drop cable; and
a bulkhead assembly for joining associated connectors to associated optical fibers, the bulkhead assembly including a body formed as part of the housing cover.

2. The closure of claim 1 wherein an outer perimeter of the body of the bulkhead assembly is formed as part of the housing cover.

3. The closure of claim 2 wherein the body is integrally molded to the housing cover.

4. The closure of claim 1 wherein the bulkhead assembly includes (i) a shroud subassembly that forms an interface between associated optical fibers received through opposite ends thereof, (ii) a flange that receives a first end of the shroud subassembly, the flange being received in one end of the body, and (iii) a seal received over the flange for sealing between the flange and the body.

5. The closure of claim 4 wherein an outer perimeter of the body of the bulkhead assembly is integrally molded to the outer cover so that separate seal member are eliminated between the body and cover.

6. A method of forming a fiber optic cable closure comprising:
providing a housing including a base and a cover, the cover including multiple ports each dimensioned to receive an associated drop cable;
providing a bulkhead assembly for joining associated connectors to associated optical fibers, the bulkhead assembly including a body; and
forming the body of the bulkhead assembly formed as part of the housing cover.

7. The method of claim 6 wherein body forming step includes forming an outer perimeter of the body of the bulkhead assembly as part of the housing cover.

8. The method of claim 7 wherein the body forming step includes integrally molding the body to the housing cover.

9. The method of claim 6 further comprising (i) including a shroud subassembly that forms an interface between associated optical fibers received through opposite ends thereof, (ii) including a flange that receives a first end of the shroud subassembly, the flange being received in one end of the body, and (iii) receiving a seal over the flange for sealing between the flange and the body.

10. The method of claim 9 wherein the body forming step includes integrally molding an outer perimeter of the body of the bulkhead assembly to the housing cover.
